(19) United States
(12) Patent Application Publication
(10) Pub. No.: US 2015/0149433 A1
(43) Pub. Date: May 28, 2015

(54) SYSTEM, DEVICE, AND METHOD FOR SEARCHING NETWORK DATA

(71) Applicant: Resultly, LLC., Chicago, IL (US)

(72) Inventor: Ilya Beyrak, Chicago, IL (US)

(73) Assignee: Resultly, LLC., Chicago, IL (US)

(21) Appl. No.: 14/090,870

(22) Filed: Nov. 26, 2013

(51) Int. Cl. G06F 17/30; H04L 12/26

(52) U.S. Cl. CPC G06F 17/30867; H04L 43/08
USPC 707/710

(57) ABSTRACT

A system that searches data within a network is disclosed. The system searches data based on when the data becomes available in the future, rather than searching data in real-time. The system can leverage existing website search engines to improve the efficiency of the search, and can provide location-based search results to improve the relevancy of the results. The system can better utilize social media searches by searching all data accessible to the user, rather than searching only the data that is publicly available. Other users of the system can interact with the search results to create a social network centered around the search results.

### TECHNICAL FIELD OF THE INVENTION

The present application relates to search engines. Particularly, the present application relates to a search engine that alerts a user when data comes into existence or is changed within a network.

### BACKGROUND OF THE INVENTION

Search engines are a common method of searching data across a network, for example, the Internet. Internet search engines typically collect information from a large number of websites, build a database, and allow a user to interface with the database to find relevant search results. A results page is then displayed to the user providing links to the results that match the search term.

Current search engines collect information in a database and allow users to search the pre-constructed database to find data matching the search term. Current search engines do not, however, receive a search term and provide results to the user once data comes into existence. The search results provided to the user can therefore be out of date because the searched-for data has not yet come into existence. For example, when searching for a flight from one airport to another, most search engines provide pricing information in real time. The search engines typically do not alert the user at some later time when the price is within the user's desired price range. Other search engines provide “price alerts” for airfare, but do not extend such alerts to other products or services. Such alerts are also the same regardless of location, resulting in search results that may not be geographically relevant.

Most internet search engines search across various websites by crawling the websites themselves, rather than leveraging website functionality to better search the website. For example, www.microsoft.com may include a search engine that can be used when a user visits the Microsoft® website. But more global search engines such as Bing® do not utilize this functionality when searching the website. A global search engine such as Bing® would therefore inefficiently crawl the www.microsoft.com website rather than using the local Microsoft® search engine to search the site.

Search engines can also search across social media websites but display data to the user that is publicly accessible, rather than the more extensive data the user may be able to see based on his or her account within the social network. For example, a user can search their social media page and find data relating to different social media members becoming “friends” or different posts of the social media members. This data is only available to the user (or users with similar “friends”) and therefore not publicly available to search engines. Common search engines are also susceptible to providing search results not relevant to the social circle of the user.

### SUMMARY OF THE INVENTION

The present application discloses a device, system and method for searching data within a network such as the Internet. Data is searched based on when the data comes into existence, rather than by searching existing data previously collected and stored within a database. The system can utilize existing website search engines to more efficiently crawl the website, and can provide location-based search results to increase the relevancy of the results. The system can better utilize social media searches by searching all data accessible to the user, and not simply the data that is publicly available. Other users of the system can interact with the search results in a manner similar to existing social media websites, and can be matched as suggested connections based on the perceived similarities of the users. For example, similarities can be established by similar search queries, or by similar results from different queries.

In particular, the present application discloses a method for searching a network including providing a search interface to a user device of a user, receiving, at a server, a search term from the user requesting search result data corresponding to the search term, monitoring a network to determine when the search result data comes into existence or changes on the network, and causing display of the search result data to the user.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic diagram of an embodiment of the present application.

FIG. 2 is a schematic diagram illustrating a user device according to an embodiment of the present application.

FIG. 3 is a flow diagram of an embodiment of the present application in which data is retrieved when the data comes into existence.

FIG. 4 is a flow diagram illustrating a process for requesting data according to an embodiment of the present application.

FIG. 5 is a flow diagram illustrating a process for matching users according to an embodiment of the present application.

It should be understood that the examples below are simply proposals such that one skilled in the art would be able to modify the proposals within the scope of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a system that searches data within a network based on when the data becomes available or changes in the future, rather than by searching existing data to match a search query. The system can utilize existing search engines to more efficiently crawl network sites, and can provide location-based search results to increase the relevancy of the results. For example, the system can tag certain search results with location information and deliver those results to only a specified region. The system can better utilize social media searches by searching all data accessible to the user, rather than by searching only the data that is publicly available. Other users of the system can interact with the search results in a social network-type manner, and can be matched based on perceived similarities.

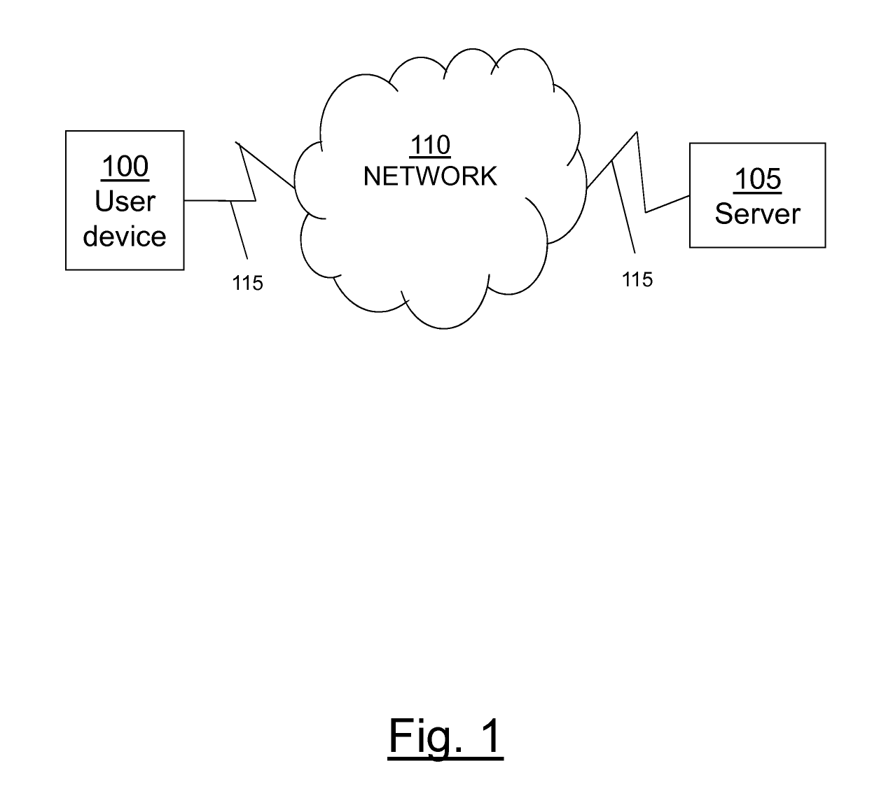

As shown in FIG. 1, the system 10 includes a user device 100 connected to a server 105 via a network 110 by way of communication links 115. The user device 100 communicates with the server 105 to transmit data to and receive data from the server 105. Such data can include search queries from the user, searched results, social media data, location data, or any other data necessary or helpful to facilitate the searching or interaction processes of the present application.

The user device 100 can be a device of any type that allows for the transmission and/or reception of data. By way of example, the user device 100 can include a smart phone (e.g. iPhone®), personal computer, voice and video telephone set, streaming audio and video media player, integrated intelligent digital television receiver, work station, radio, personal digital assistant (PDA), mobile satellite receiver, GPS receiver, software system, or any combination of the above.

The server 105 can also be a device of any type that allows for the transmission and/or reception of data, and that is capable of storing information to be transmitted to the user device 100. For example, the server 105 can include any device listed above with respect to the user device 100, or can include a non-transitory computer-readable recording medium, such as a hard drive, DVD, CD, flash drive, volatile or non-volatile memory, RAM, or any other type of data storage. As used throughout this application, the term “non-transitory computer-readable recording medium” excludes only signals and carrier waves, per se, and is not meant to exclude other types of memory that may be considered “transitory” such as RAM or other forms of volatile memory. Also, the server 105 can include multiple servers 105, such as a “server farm”, and may further include a server 105 in combination with a load balancer or other functionality that improves the efficiency of the server 105.

The network 110 may be a single network or a plurality of networks of the same or different type. For example, the network 110 may include a local telephone network (such as a Bell Atlantic telephone network) in connection with a long distance network (such as an AT&T long distance telephone network). Further, the network 110 may be a data network, an Intranet, the Internet or a telecommunications network in connection with a data network. Any combination of telecommunications and data networks may be used without departing from the spirit and scope of the present application. For purposes of discussion, it will be assumed that the network 110 is the Internet.

The communication links 115 may be any type of connection that allows for the transmission of information. Some examples include conventional telephone lines, fiber optic lines, direct serial connections, cellular telephone connections, satellite communication links, local area networks (LANs), intranets, and the like.

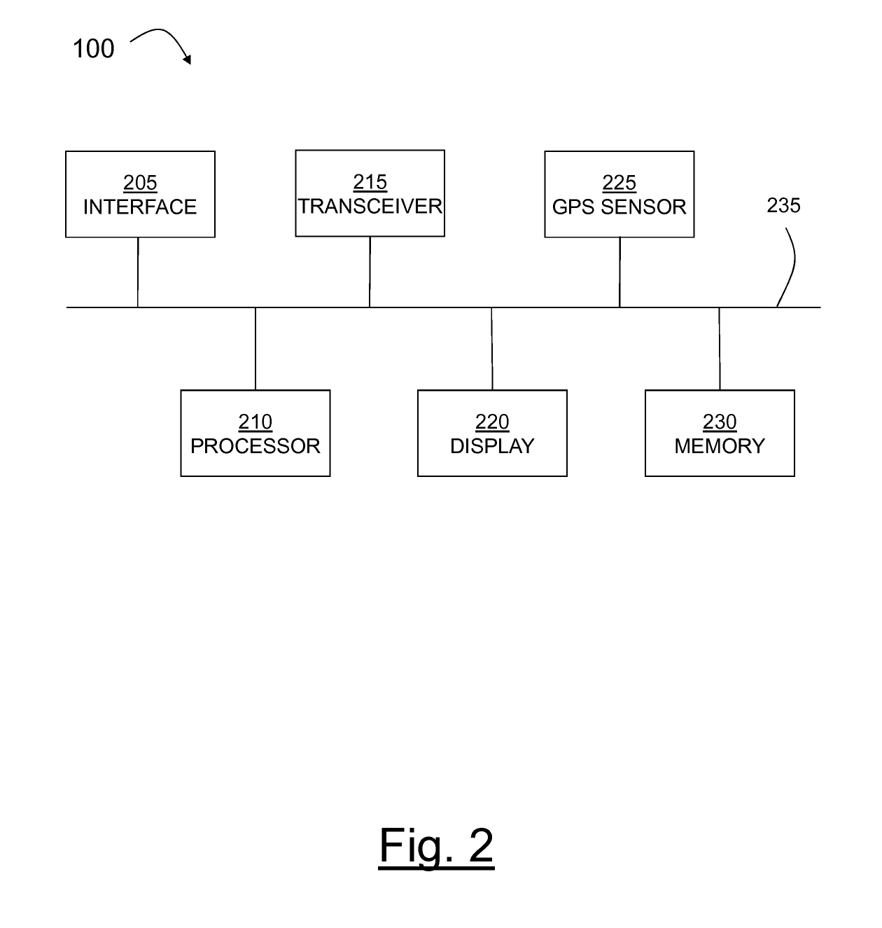

FIG. 2 is a schematic diagram illustrating the hardware components of the user device 100. As shown, the user device 100 can include an interface 205, processor 210, transceiver 215, display 220, GPS sensor 225 and a memory 230 connected via a bus 235.

The interface 205 allows the user to input information or commands into the user device 100 and to openly transmit the information or command to the server 105 via the network 110. By way of example, the interface can include a keyboard, mouse, touch screen, audio recorder, audio transmitter, member pad, or any other device that allows for the entry of information from a user.

The processor 210 facilitates communication between the various components of the user device 100. The processor 210 can be any type of processor or processors that alone or in combination can facilitate communication within the user device 100 and, together with the transceiver 215, transmit information from the user device 100 to external devices. For example, the processor 210 can be a desktop or mobile processor, a microprocessor, a single-core or a multi-core processor.

The transceiver 215 can be any device that can transmit data from the user device 100 or can receive data within the user device 100 from an external data source. By way of example, the transceiver 215 can be any type of radio transmission antenna, cellular antenna, hardwired transceiver, or any other type of wired or wireless transceiver that is capable of communicating with an external device.

The display 220 can display various information for the user to view and interpret, including a search engine interface, search results, or requests for the user to input information via the interface 205. By way of example, the display 220 can include a liquid crystal display (LCD), organic light emitting diode (OLED) display, plasma screen, cathode ray tube display, or any other kind of black and white or color display that will allow the user to view and interpret information on the user device 100.

The GPS sensor 225 can allow the user device 100 to determine its current GPS coordinates and thus determine the user's geographic location. The GPS sensor can also be a desktop computer that provides location information based on its IP address or other indications. As discussed below, the location information of the user device 100 can be used to better deliver search results by determining the geographic relevancy of the results.

The memory 230 can store any information including commercial offers or search results received from the server 105 via the network 110. The memory 230 can also store an operating system for the user device 100 or any other software or data that may be necessary for the user device 100 to function. Similar to the server 105 discussed above, the memory 230 can include any non-transitory computer-readable recording medium, such as a hard drive, DVD, CD, flash drive, volatile or non-volatile memory, RAM, or any other type of data storage.

The bus 235 acts as the internal circuitry of the user device 100 and electrically connects the various hardware components of the user device 100. The bus 235 can be any structure that performs such a function.

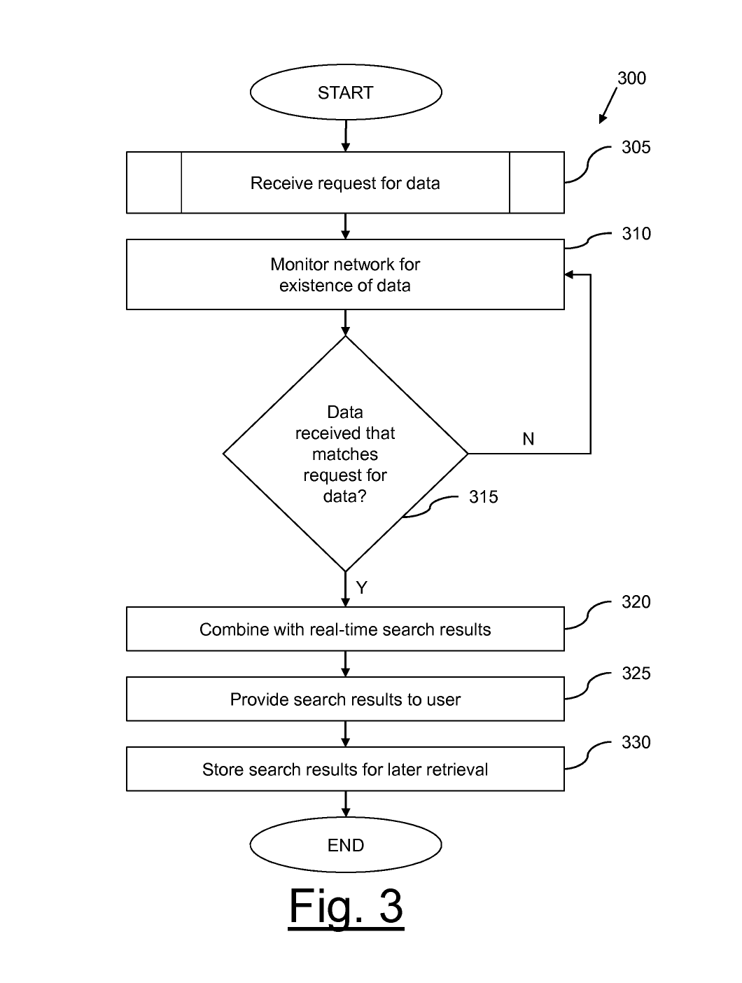

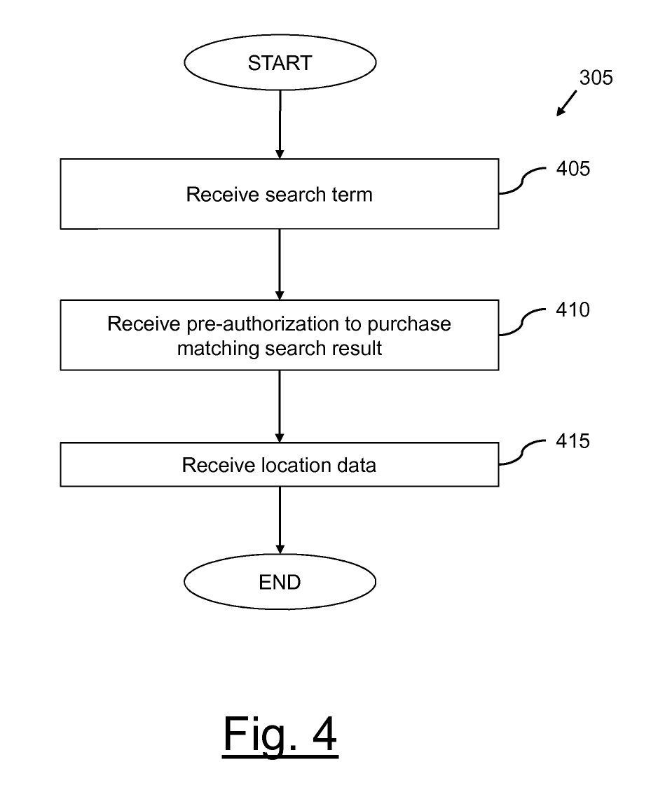

FIG. 3 illustrates a flow chart according to an exemplary embodiment of the present application. As shown, the process 300 begins and proceeds to step 305, where a request for data is received. For example, the request for data can be received by the server 105 after the user inputs the request for data into the user device 100. The request for data is typically a search term entered into the interface 205 of the user device 100, but can take any form. Further detail regarding step 305 will be discussed below with respect to FIG. 4.

The process 300 then proceeds to step 310, where the network 110 is monitored for the existence of data that matches the request for data. The process 300 then proceeds to step 315, where it is determined whether any data has been received that matches the request for data. For example, the process 300 can monitor the network 110 in step 310 for a product being offered at a particular price, and in step 315, determine whether a website has offered the product at the specified price. If existing data matches the request for data, the process proceeds to step 320. If not, the process reverts back to step 310 and continues to monitor the network 110.

Step 310 can search for data matching the request for data by leveraging existing search engines of the searched-for websites. For example, the process 300 can search the Microsoft® website by using the existing search engine on www.microsoft.com (hereinafter referred to as a “local search engine”), rather than by crawling the entire Microsoft Website®. Here, the process 300 can first search the website to determine whether a local search engine exists and, if so, enter a search term into that search engine to determine whether relevant data exists on the website. The relevant data can then be transmitted back to the server 105 and then to the user device 100, or alternately, directly to the user device 100. The efficiency of the searching process is therefore improved over conventional searches that manually crawl websites without utilizing existing search engines found on the website.

For local search engine searches, step 315 can de-duplicate queries from a plurality of users and then normalize them. For example, if User 1 searches for “iPhone 5” and User 2 searches for “IPhone 5”, the system can normalize the results by first reducing to lower case and establishing that the two above searches are for the same content. Also, if User 1 searches for “iPhone 5 new” and User 2 searches for “new iPhone 5”, the system alphabetizes the separate words to determine that the queries are the same. If, however, User 1 searches for “iPhone 5 white” and User 2 searches for “iPhone 5 black” the system can determine the similarities in the search (here, the request for an iPhone), and perform that search once for both users, and afterwards, performing a second search for each user based on the difference in the queries (here, the color of the iPhone). In an embodiment, the process 300 searches sites that match the category of a query. For example, if the query is for products, the process 300 only searches e-commerce sites. If the query is for a category such as airfare, the process 300 only searches airline or travel sites.

The system can also include a process for learning the category of web pages, web sites, or web content provided by the web site. For example, the process can load various web pages and allow users or computer technicians to manually label the category of the web page or web content. The system can then learn the page and extract various objects from the page to automatically determine the category of the page, e.g., a product page. Over time, the system can then avoid the need for manual category identification and automatically identify the category of various pages.

Step 310 can also search for data by utilizing a website's API. The API can be private, meaning restricted to users with appropriate logins (e.g., the user's Facebook or Twitter login), or can be public and not require any login information. For public APIs, step 310 can crawl appropriate web pages using the a website's API search function or use specific data functions to retrieve data. If no search function is available, the system can obtain applicable data via the API, store a record of the search results, and find user queries that may be possible matches. If the API is private and therefore restricted, step 310 can search for data individually for each user by using the specific user's login credentials or other identifying indicia that grant the ability to view restricted data. The system can also obtain an exclusive API connection to various web sites to stream line the data retrieval process. For example, the system can agree with a merchant, in advance, on how the system interacts with the vendor to obtain data through an API that is reserved strictly for the system. Alternatively, or in addition to the above, the system can allow third party web sites to access the API of the system to retrieve information and aid in the searching process.

If a query is brand new in its normalized fashion the system can perform an initial search of the search results. In some embodiments, step 315 can request that the site sort results based on the time the results came into existence, or other criteria identifying which results are more current than others. Later, the system can repeat the search and compare the second set of results to the first set of results in order to determine which results are new and identify changes within the searched for data. Those changes can later be displayed to the user as relevant results.

In some embodiments, the process 300 searches data only up to the last found result. For example, a first search can obtain results 1-10 from a website, and a second search can receive different results for the first seven matches (due to the results being more current than previous results 1-7) but the same results for matches 8-10. The process 300 in this instance could forego results 8-10 and provide only results 1-7. Alternatively, the process 300 could provide all 10 results, but retrieve results 8-10 from memory and avoid duplicative processing.

Step 315 can also match collected data against a user's interests and apply user-set filters (e.g., price, color, location) for matching purposes. The matches are then created uniquely for the user in a personalized set of results termed “User Results”. For example, one general search result may result in ten individual user results if ten users had interests matching the general result. The process can then deliver the User Results to the user via appropriate means and provide a user-customized set of results based on predetermined user interests.

Another method of obtaining data is by performing specialized crawling. This method is beneficial for traditional retailers and other types of websites that are relatively static in nature, i.e., remaining constant in their items rather than adding a significant number of items each day. Step 310 can first crawl web pages on a given website, and identify pages that are relevant to the results, e.g., by identifying product pages in response to a product search query rather than providing all other pages on the site. Step 310 can then store the results (e.g., as a link in URL form) and optionally store meta data relevant to the results (e.g., the name, description, price, color, etc. of the product). The process 300 can then identify the results that match user queries in step 315, and reload the web pages from the website at a high frequency rate to provide more up to date results to the users. To achieve up to date results for future search queries, step 310 can re-crawl the website after an initial matching of results and user queries/interests, without matching the results received in the initial data retrieval and matching step. This method allows the process 300 to crawl quicker and find new web pages. As new items come into existence, the process 300 creates user results based on matches with user interests and search results.

The manner of interfacing with the network 110 can be modified by the user, the server 105, or the site monitored by the server 105. For example, the user may decide that API monitoring is insufficient and instead request that the server 105 perform periodic real-time searches of the network 110 using website search engines. An Internet website, however, could determine that API interfacing is burdensome for the website and instead only permit periodic real-time searches. To aid in the searching process, users of the system 10 can label content of the websites with categories or other information identifying the data, and the process 300 can search for the user-defined data when monitoring the network 110.

Step 320 illustrates an optional aspect of the present application in which the process 300 combines received search results with real-time search results. For example, results matching the request for data can be combined with the search results that would have been received by a conventional search engine when requested at the time of the request for data, or can be combined with real-time search results obtained at the time the matching data is received. This process can illustrate to the user how conventional search engines obtained relevant data and contrast the conventional search engine data with the data received from the process 300.

The process then proceeds to step 325 where the search results are provided to the user. For example, the server 105 can transmit the search results to the user device 100 through the communication links 115. The user can then view the search results on the display 220 of the user device 100. Search results can be provided in a webpage format with links to webpages matching the requested data. The user can be alerted of the search results in any manner, for example, by an email, text message, or telephonic “alert” or by a mobile application providing a “push notification”. Any information can be included in the search results, such as the degree of relevance of the results, the time the result came into existence, or any other information.

Step 320 can also provide a combination of search results to the user based on searches performed by multiple users. For example, assume User 1 enters a search query and receives results relevant to that search query. The system determines that User 2 is similar to User 1 based on similar “friends”, age groups, and the similarity of User 2's results to the same, similar, or different search query as User 1. The system can therefore provide User 1 with some or all of User 2's results in combination with the results User 1 would typically receive based on the search query.

Also in step 325, the search results can be provided to the user based on location-based data of the user. The search results can be displayed on the user device 100 by relevancy to the user's current location (as determined by the GPS sensor 225) or by the location entered by the user at some previous time. For example, the search results can provide the user with the closest store that sells the product searched for by the user. The search results can also provide the user with location-based mapping to direct the user to the store. Any other location-based results can be implemented without departing from the spirit and scope of the present application.

Step 325 can present location-based results in a unique manner by labeling certain results with location information and storing those results at the server 105. When the server 105 later receives a search query, step 325 can match the location information of the user and match against the location information of the results stored at the server 105. Users are therefore more likely to receive search results relevant to their geographic location.

Optionally, in step 330, the search results can be stored for a future user having a similar request for data. The search results can be stored in a memory of the server 105 or in the memory 230 of the user device 100. The search results can be later retrieved when a request for data is similar, for example, to one or more identifying feature of the search results. Following step 330, the process 300 ends.

FIG. 4 illustrates a more detailed flowchart of the process of receiving a request for data 305. As shown, the process 305 begins and proceeds to step 405, where a search term is received. Here, a user can input a search term in a search query interface displayed on the user device 100. For example, a user can enter a search term for a particular product at a particular price and await the time when the specified product is sold at the specified price.

The user can also request that the process 300 purchase the specified product when offered at the specified price, as shown in step 410. For example, the user can enter credit card information and pre-authorize the process 300 to use that credit card to purchase the product. The user can implement this option for all searched-for products or on a product-by-product basis. For security purposes, this method would benefit from a partnership with the individual merchant to be able to pass the user's billing details to the merchant. Step 410 can therefore detect an appropriate item and send billing details and purchase instructions through the API.

The user can also enter location-based data to better tailor the search results, as shown in step 415. For example, the user can manually enter a specific location that is geographically relevant to the search results, or can request that the process 300 treat the user's GPS location as the relevant location-based data to be analyzed when monitoring the network for data or when delivering search results. Results for a news story, for example, will be relevant to a user only if located within the user's city.

The disclosed systems of the present application can also be implemented within a social network or have social network attributes that better facilitate interaction between users of the system. For example, the process 300 can also monitor the network 110 based on the data available to the user, rather than all publicly available data. For example, if the request for data is for social network data, the user requesting the search will have access to more social network data based on the user's “friends” or connections and the more lenient privacy restrictions of those connections. The step of monitoring 310 can therefore review more data than a standard website crawl search by monitoring not only the data that is publicly available, but also the data that is available only to the user requesting the data or those users with similar social network “friends”. The process 300 may request the user to authorize a search of the more private social network data, or request the user log in to the social network in order to obtain access to the additional data. Through the social network API, the process can frequently refresh all the latest data that the user can see on the social network, and compare against previous values to see what is new.

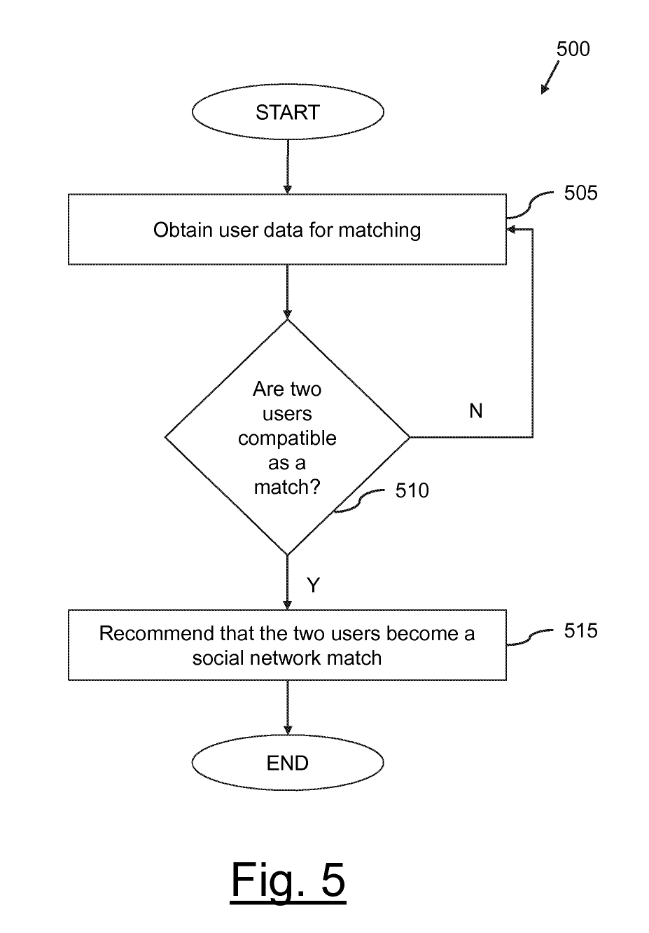

In step 330, the search results can be stored so as to allow interaction with the search results from users of the system 10. Once the search results are provided to the user, the results can be publicly displayed and fellow users can “like”, “forward”, or “share”, or otherwise interact with the search results in a social network environment. The users can become social network “friends” with each other or “follow” each other by known social networking functionality and, as described below with respect to FIG. 5, the system 10 can suggest friend connections based on similarity determinations.

Social interaction can involve a user having a profile page available on the Internet in an application. The profile page can highlight the user's interests (e.g., past search queries) that the user has chosen to make public. Within each interest the profile can display the details of filters and other query information of the user. For example, the profile can display past results, past search queries, product filters, location filters, previously entered user interests, or any other information. Another user may interact with the first user's interest by leaving a comment on an interest, adding an interest to their own interest list, liking the interest, or in any other manner. The profile page can also show a timeline summary of recent actions like when the user has added an interest, commented on an interest, commented on a result, received a new result, “favorited” a result, followed a new user, or any other event. A user viewing another user's profile may choose to follow that user, and receive updates from the user with the user's timeline of events merged with that of other followed users.

Timeline information can be universal to all users or can be available only to specific users based on privacy controls. For example, when a user leaves a comment on a set of search results, anyone using the process 300 can view the results. In an embodiment, results, interests, and profiles can all be seen without logging in to the process 300, and are visible online without unique login or identifying information.

A process of matching users of the system 10 will be described below with respect to FIG. 5. As shown, the process begins and proceeds to step 505, where user data is obtained for future matching. For example, the process 500 can obtain data related to past searches, interaction with the system 10 in a social network capacity, mutual friends of the two users, or any other data relevant for matching users. The process 500 can also obtain data from outside of the system 10 to better perform a matching function and recommend connections to users of the system 10.

The process 500 then proceeds to step 510, where it is determined whether two users are a “match” based on the user data received in step 505. If the users are not a match, the process 500 reverts back and continues obtaining user data until two users are determined to be an appropriate match. Alternatively, the process 500 can instead determine that the two users with the greatest compatibility are a match regardless of whether the compatibility is above a predetermined threshold.

In an embodiment, a match is determined as follows in step 510. As described below, represents the users of the system at any specific time; represents uniform resource locators (URLs) for all search results of all users of the system; and Rᵢ, Rⱼ . . . , Rₙ represents the URL search results of the individual user Uᵢ, Uⱼ . . . , Uₙ. In order to compute compatibility of two users and, step 510 determines the search result URLs common to both users.

R_{i,j}=Rᵢ∩Rⱼ

The compatibility index r_{i,j} is then determined as the number of URLs in both Rᵢ and Rⱼ. A compatibility matrix is then generated:

$$M = [ \begin{matrix}{r}_{1 , 1} & … & {r}_{1 , n} \\ ⋮ & ⋱ & ⋮ \\ {r}_{n , 1} & … & {r}_{n , n}\end{matrix} ] ,$$

which describes the compatibility between any two users of the social search environment. Two users are then recommended for a social network friendship based on the compatibility index exceeding a certain threshold:

r_(i,j)≧δ [symbol] friendship recommendation

The compatibility index can either be manually input by the user, by an operator of the server 105 or system 10, or can be automatically determined based on the existing friendship connections among users of the system 10. Although the URL search results are compared in the above example, any commonality of the search results can be analyzed to determine the degree of compatibility between the two users. For example, similarities can be established by similar search queries of two different users, or by similar results from different queries of two different users.

Once it is determined that two users are compatible as a match, the process 500 recommends the users become social network friends 515. The recommendation can be conducted in any manner, such as through an email, text, or telephonic alert; or by issuing a push notification from a mobile device. Any other manner of communicating with the user to suggest a social network match can be conducted without departing from the spirit and scope of the present application.

The above processes are discussed and illustrated as occurring in a particular order, but the present invention is not so limited. The processes discussed above can occur in any logical order and any of the individual steps are optional and can be omitted. The order of the steps in the claims below are also not limiting unless clearly specified in the claims.

In the above process, the network 110 is commonly discussed as being the Internet. However, the present invention is not so limited. The network 110 can be any group of computers or databases coupled together in any manner.

Many of the features discussed below are consistently described in the singular or plural. However, consistent with the present invention, the features can be either singular or plural, without exception. For example, the server 105 discussed above is commonly referred to in the singular, but can be implemented as a server farm having multiple individual servers. The network 110 can also include multiple networks, for example, multiple Local Area Networks (LANs), or the like.

The term “coupled” is used herein and in the below claims to describe a general connection between two or more entities. Absent discussion to the contrary, the term “coupled” is not intended to indicate any direct physical connection between two or more entities and can encompass direct or indirect connections via physical, electrical, mechanical, electromagnetic, magnetic, or chemical means.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicant's contribution. The actual scope of the protection sought is intended to be defined in the following claims when viewed in their proper perspective based on the prior art.

What is claimed is:

1. A method for searching a network comprising:
providing a search interface to a user device of a user;
receiving, at a server, a search term from the user requesting search result data corresponding to the search term;
monitoring a network to determine when the search result data comes into existence or changes on the network; and
causing display of the search result data to the user.

2. The method of claim 1, wherein the step of monitoring a network comprises accessing a local search engine of a website and searching the website with the local search engine.

3. The method of claim 2, further comprising determining whether the website includes the local search engine, searching the website for the local search engine, and transmitting the search results from the website to the server.

4. The method of claim 1, further comprising receiving, at the server, data corresponding to user labels provided to content of the network by users of the network.

5. The method of claim 4, wherein the step of monitoring the network includes searching for categories of data corresponding to the search term.

6. The method of claim 1, wherein the step of receiving the search term includes receiving location data from the user, and wherein the search results data further correspond to the location data.

7. The method of claim 1, further comprising causing the display of the search results data for multiple users, and receiving social media interaction from the multiple users relating to the search results data.

8. The method of claim 1, further comprising conducting a real-time search for real-time search results corresponding to the search term, receiving the real-time results, combining the search results with the real-time results to obtain combined results, and providing the combined results to the user.

9. The method of claim 1, wherein the search results relate to a purchasable product or service, and the step of receiving the search term includes receiving a pre-authorization request authorizing the server to complete a purchase of the product or service when the search results are received at the server.

10. The method of claim 1, further comprising determining a set of data accessible to the user on the network, wherein the set of data includes private data that is not publicly accessible, wherein the step of monitoring the network includes monitoring the set of data, and the step of causing the display of the search results includes causing display of the set of data.

11. The method of claim 10, further comprising requesting a user login and searching application programming interfaces using the user login.

12. The method of claim 1, further comprising de-duplicating the search result data and proving non-duplicative search result data to a plurality of users.

13. The method of claim 1, further comprising monitoring the network again to obtain second search result data, comparing the second search result data with the search result data, and causing display of the step of comparing to the user.

14. The method of claim 1, further comprising determining a similarity of search results received by the two users, and recommending a social network connection between the two users if the similarity is above a predetermined threshold.

15. The method of claim 14, wherein the step of determining a similarity of the search results is conducted by calculating:
r_(i,j)≧δ
where r_{i,j} represents a number of common search results for user Uᵢ and Uⱼ, and represents a threshold upon which the social network connection is suggested for users Uᵢ and Uⱼ.

16. The method of claim 15, wherein is input manually by at least one of the user or an operator of the server.

17. The method of claim 15, wherein is determined automatically by the server.

18. The method of claim 14, wherein the similarity is based on the search results obtained from different search terms.

19. The method of claim 1, wherein the search term is a user interest entered into a user profile.
